(19) United States
(12) Patent Application Publication
(10) Pub. No.: US 2002/0065074 A1
(43) Pub. Date: May 30, 2002

(54) Methods, systems, and devices for wireless delivery, storage, and playback of multimedia content on mobile devices

(76) Inventors: Sorin Cohn, Chapel Hill, NC (US); Marshall Brent Ross, Apex, NC (US)

Correspondence Address: Joshua Ford, Wireless Multimedia Solutions, Second Floor, 2530 Meridian Parkway, Durham, NC, 27713, US

(21) Appl. No.: 10/040,617

(22) Filed: Oct. 23, 2001

Related U.S. Application Data
(60) Provisional application No. 60/242,507, filed on Oct. 23, 2000.
(60) Provisional application No. 60/242,509, filed on Oct. 23, 2000.
(60) Provisional application No. 60/242,508, filed on Oct. 23, 2000.
(60) Provisional application No. 60/242,441, filed on Oct. 23, 2000.

(51) Int. Cl. H04Q 7/20

(52) U.S. Cl. 455/422; 455/403

(57) ABSTRACT

Data communication systems, methods, and devices for transmitting multimedia data content to wireless devices and, more particularly, methods, systems, and devices to deliver, store, and playback multimedia content on a handheld wireless device. The data communication system includes a content server and proxy server that store and mark multimedia data content as single-use or multi-use data. The marked data is transmitted to a wireless held device where the data is stored and provided with an indicator based on whether it is single-use or multiuse data, and then is routed to a media player for play back. After playback, the data is either deleted or stored, depending on the indicator attached thereto. The data may also be marked as restricted data and stored on a restricted access area. A block retransmission program is also provided to restore data transmission from the proxy server in the event transmission is prematurely lost. The data communication systems, methods, and devices according to the present invention provide a more efficient and better quality of service in the delivery, storage, and playback of multimedia data in a mobile device platform.

### RELATED APPLICATIONS

This application is based upon and claims priority of U.S. Patent Application Nos. 60/242,507; 60/242,509; 60/242,508; and 60/242,441, all filed on Oct. 23, 2000, the contents of which are incorporated herein by reference.

### FIELD OF THE INVENTION

The present invention relates generally to methods, systems, and devices for transmitting multimedia content to wireless devices and, more particularly, to methods, systems, and devices to deliver, store, and playback multimedia content on a handheld wireless device.

### BACKGROUND OF THE INVENTION

Wireless communications provides one method for mobile users to communicate to a wired network. In particular, wireless communications allows consumers to receive and send information. Examples of such wireless networks include cellular phones, pager systems, and satellite systems. The wireless network systems can be broken into relatively high bandwidth and low bandwidth systems. High bandwidth systems are for example satellite systems. Lower bandwidth systems include cellular phones and mobile radio systems. Still lower bandwidth systems include pager networks and low bandwidth packet switched radio systems (e.g., the BellSouth Mobile Data Mobitex.TM. system).

One area in which Web access is becoming more desirable is in handheld devices. Handheld devices are emerging as important computer devices. Handheld devices typically implement a relatively small, but important function set. Examples of such handheld devices are the PalmPilot™. handheld device available from Palm Corporation, Inc. of Santa Clara, Calif., as well as PocketPC™ devices like the Hewlett-Packard Jornada, the Compaq iPAQ, or smartphones like the Nokia 5510, the Kyocera 6035 or the Samsung I300 Examples of the function sets supported are address books, calendars, and task lists.

Delivery of data content to a handheld device can occur in several different manners. A typical system is illustrated in FIG. 1. FIG. 1 illustrates a network diagram of devices and content providers 10. In this system, network 10 includes a single use content server 11 that stores and sends data that can only be used once by a particular user, and a repeated use content server 12 that stores and sends data that can be accessed repeatedly by a user. Both content servers 11 and 12 are connected through the Internet 13 to a push proxy or push server platform 14. Push server platform 14 stores data from content servers 11 and 12 and can be accessed by various users through, for example, a service provider. Push server platform 14 therefore acts as a buffer for downstream users.

Push server platform 14 transmits single use or repeated use data through a data network, here represented by telephone network 15 and cellular network 16. Data from cellular network 16 is sent to a transmission device 17 to be transmitted wirelessly to a wireless handheld device 18, which can be, for example, a PDA, cell phone, handheld computer or the like.

Current generation wireless devices have limited media playback and storage capabilities, and primarily depend on streaming content for presentation. This implementation is effective and sufficient for low quality media playback on demand for devices having a small memory footprint. Next generation wireless devices will be capable of connecting to broadband wireless data streams, and the need to cache and store content delivered on the device becomes much more important.

Of equal importance to users is the ability to have access to the desired content at times convenient to them and in environments where they may be bereft of direct wireless coverage.

Several previous inventions; e.g. 34,976, cover specific issues related to the delivery of spoken word and audio messages to mobile devices over frequency reuse networks. Other inventions; e.g. 6,298,231, deal with the transmission and deposition of any content messages into a wireless device, but do not cover the issues related to playback and management of the content on the mobile device.

The present invention is directed to overcoming, or at least reducing the effects of, one or more of the problems set forth above. The present invention is concerned with the delivery, storage and playback of data transferred through wireless data streams in an efficient manner to provide easy accessibility to important data, high quality playback and better service on the “user's own terms”.

### SUMMARY OF THE INVENTION

The present invention relates to the wireless delivery, downloading, playback and management of multimedia content on a mobile device. More particularly, the present invention is directed to systems, devices, and methods for quality delivery, storage, playback, and management of multimedia content on a wireless device.

A system according to a preferred embodiment of the present invention includes a content storage device that stores and transmits a data stream, and a proxy server that receives the data stream sent from the content server. When the proxy server receives the data stream, it is marked as single-use data or multi-use data, and is stored until accessed by a user. Then, the proxy server transmits at least a portion of the marked data to a data network, where a transmission device transmits the data from the data network to a wireless device.

According to the preferred embodiment of the invention, the wireless device includes a storage area that stores data from the data stream sent from the transmission device. The wireless device further includes a memory subsystem capable of executing several different data management programs. The data management programs can include, but are not limited to the following: a data indicator program to determine the type and status of the data in the storage device, i.e., whether the data is single-use or multi-use; a data player program to facilitate routing of data to a data-player on which the data from the storage device is played back to a user; a personal storage access area program to mark certain data as restricted access data that can only be accessed by a particular user and storing that data in a personal storage access area; and a block retransmission enabling program to detect when a transmission signal from the proxy server is prematurely lost and to initiate a block retransmission enabling signal to the proxy server to re-establish the communication link and resend the last partially received block of data, together with the remaining data that needs to be transmitted to the device.

### BRIEF DESCRIPTION OF THE DRAWINGS

FIG. 1 shows a system diagram of a wireless communication system, in accordance with the invention;

FIG. 2 shows a flow chart diagram of a method for storing data content on a push server, in accordance with the invention;

FIG. 3 shows a flow chart diagram of a method for receiving and assigning status setting to data received from the push server, in accordance with the invention;

FIG. 4 shows a flow chart diagram of a method for play back of multi-use data, in accordance with the invention;

FIG. 5 shows a flow chart diagram of a method for play back of single-use data, in accordance with the invention;

FIG. 6 shows a workflow diagram describing a method for assigning a secure status indicator to received data and storing that data in a personal storage access area, in accordance with the invention;

FIG. 7 shows a workflow diagram describing a method for re-establishing contact with a push server if data transmission from the push server is prematurely lost, in accordance with the invention; and

FIG. 8 shows a block diagram of a wireless device, in accordance with the invention.

### DETAILED DESCRIPTION

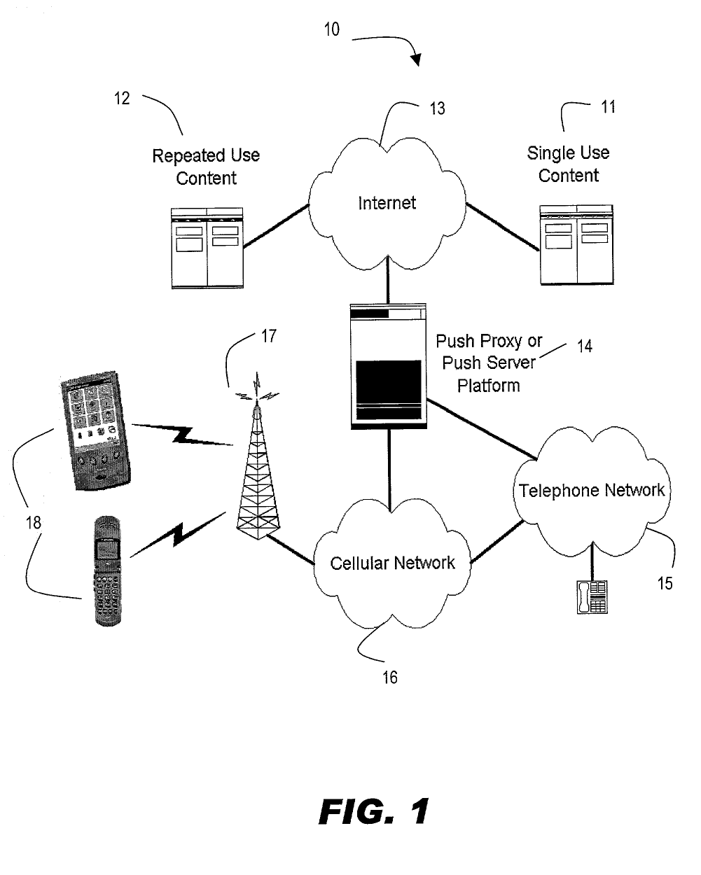

As noted above, FIG. 1 illustrates a network diagram of devices and content providers 10. In this system, network 10 includes a single use content server 11 that stores and sends data that can only be used once by a particular user, and a repeated use content server 12 that stores and sends data that can be accessed repeatedly by a user. Both content servers 11 and 12 are connected through the Internet 13 to a content delivery server, e.g. a push proxy or push server platform 14. Push server platform 14 stores data from content servers 11 and 12 and can be accessed by various users through, for example, a service provider. Push server platform 14 therefore acts as a buffer for downstream users. Push server platform 14 transmits single use or repeated use data through a data network, here represented by telephone network 15 and cellular network 16. Data from cellular network 16 is sent to a transmission device 17 to be transmitted wirelessly to a wireless handheld device 18, which can be, for example, a PDA, cell phone, handheld computer or the like.

For the purpose of describing the invention, the following two Service Provider models will be used. It should be recognized that while these models are used to describe the invention, other service provider models could be within the scope of the invention as well. A Repeated Use Mode relates to content providers delivering single payment and subscription-based media to desktops over the Internet. This content can range from audio clips and spoken periodicals to books on tape, from graphical maps to full audio-graphic presentations, from text-and-graphics manuals to pictures and full motion video. A Push Server will allow this provider to deliver content to mobile devices for replay at a subscriber's convenience. An example of this type of content provider is Audible.Com. Other providers that can be cited are Yahoo, AOL, Vivendi, and myriads of other content providers and enterprises attempting to disseminate their information to employees and customers alike.

A Single Use Model relates to content providers delivering media to devices in the form of one time use media. The content is tailored to a customer's listening or viewing preferences and may contain advertising to defer production costs. A Push Server will facilitate the delivery of this content to mobile devices. Several companies currently utilize this model to deliver services such as Internet radio or TV to wired desktop devices.

Providers send content to PC or PDA based subscribers on a periodic basis. A customer goes to the provider's site and pays for a range of periodic or special offerings. A user is granted rights to listen to, or view the offerings, but not to reproduce or re-transmit the products to anyone else. The content is presented using proprietary decoders, certified media players, or through applications such as RealPlayer.

A customer could elect to have content delivered to a mobile Internet capable device and review it at their leisure or have it streamed in real time. The present invention is directed to devices that store content locally and allow playback when not connected to a service provider. The following is a list of steps necessary for device storage and playback on any mobile device, and the particular device that carriers out the steps:

1. The content is stored on the device and confirmation is returned to the push server. The browser is responsible for guaranteeing persistent store before confirming delivery to the push server [Browser].

2. When delivery is complete, the browser will display a dialog box to the screen that content was delivered [Browser].

3. The browser will execute the player plugin if the user confirms the dialog box [Browser].

4. The player will receive a reference to the content from the browser and open the file [Browser, Player].

5. The player will decode the content header and body and begin playback. The player will allow the user to play/resume, pause, rewind, fast-forward, stop, and delete [Player].

For file-based repeated use audio content to be played on mobile devices, some additions to the specifications are necessary. What follows are features necessary for a generic player application to play high quality media content on a mobile device:

1. Confirmation screen: The microbrowser must be able to notify the user that the content is stored via a confirmation screen and pass the file location to the player. The screen alerts the user new content is available and prompts the user for playback or some other action e.g., (save, delete, play, etc) If playback is selected, the microbrowser executes the player and passes the location of the stored file to the player.

2. MIME type: This identifies the media file specific to the player application. The browser would run the content based on the MIME type. For example, the MIME format for Audible.Com could be:

application/vnd.audible

3. Lock Status Indicator: The lock status indicator (LSI) allows the player to determine the current state of the file. The LSI would let the player know if the content has been played yet, or if it has been deleted by the user.

4. Set LSI marker for deletion: The set marker allows the user to mark unwanted content for deletion. If marked as such, the content can be overwritten when new audio is downloaded.

5. Protected area archive: This allows the user to archive a file for future playback. The protected area is a secure area where the media file will not be removed without confirmation. The user can use this area to save content for future reference.

6. Track information: Track information displays the following file attributes from the file header:

a) Track name: lists current track name.

b) Artist or author name: displays artist and/or author names for spoken, music, presentation or video tracks. An identifier such as phone number, user name, or network address can be displayed as well.

c) Total track time: lists total track time in hours, minutes and seconds.

d) Copyright information: displays book or music copyright date and owner of copyright.

e) Bit rate: gives encoding bit rate of audio file

f) File type and/or player software: required for playback/presentation.

7. Security public/private keys: The device contains a private key that is used to decrypt the audio file. This private key is device-specific and cannot be transferred. The public key is encoded into the media file from the content provider and decrypted at the device using a composite of public and private keys.

8. Device record to audio file: The device records a user's audio into a media file with populated content headers. Track name and authors name defaults to filel and user's name respectively. Track name and authors name can be edited. Copyright information cannot be entered. Voice recordings can be forwarded between devices.

9. Device record of voice annotation: This allows a user to record additional audio content to an existing media file. If the original media content is copyrighted, annotated content cannot be forwarded. Non-copyrighted material can be annotated and sent back and forth between devices.

10. Device record for image (graphical, picture static or motion video) annotation: This allows a user to insert and record additional image content to an existing media file. If the original media content is copyrighted, annotated content cannot be forwarded. Non-copyrighted material can be annotated and sent back and forth between devices.

For one time use storage, the device must be able to store the content, regardless of type, to the local storage media. Storage should be possible to single or multiple storage devices if present on the device. Playback would be limited to one time from start to finish. Users would be able to suspend playback but never to go backwards and replay an item. The content provider, for copyright reasons, usually imposes this restriction. The same items from the repeated use model are utilized in this model as well. What follows are the additional steps necessary for one-time use content to be stored and used on a mobile device:

1. The media player needs to maintain a Persistent Progress Indicator (PPI) to identify how far playback has progressed through the content file [Player]. The PPI will allow the media player to resume from the previous position after it is stopped by storing the latest relative position during playback.

2. The media player MUST not allow the content to be played twice or backed up to replay a section [Player]. The PPI or similar construct is necessary for this function.

3. The media player must reset the PPI and set the LSI marker for deletion at the end of content playback. This allows the content to be played only once [Player].

The media player should support resumption of file transmissions when a connection is prematurely terminated [Player]. This is a facility that would use transmission checkpoints to confirm delivered blocks, and resume from the last successful point. Applications need to be declared Block Re-transmission Enabled (BRE) to comply with this specification.

Another aspect of the invention is a way to implement a content delivery offering with a content provider. A customer would elect to have content delivered to a mobile Internet capable device and review it at their leisure or have it streamed in real time. For this discussion, the invention will focus on devices that store content locally and allow playback when not connected to a service provider. What follows is a list of steps necessary for content delivery and device storage on any mobile device:

1. A customer registers for content at either their service provider or the content host [content provider such as Audible.Com].

2. The content is delivered to a push proxy or push server platform for transmission to a mobile device. Included with this content are destination routing instructions.

3. The server queries the device to determine its user profile operating characteristics. This process ensures that the device is given content appropriate to its screen size, CPU, memory, etc.

4. The server initiates a session to the mobile device and transmits the content.

5. The content is stored on the device and confirmation is returned to the Push server.

For repeated use storage, the device must be able to store the content, regardless of type, to the local storage media. Storage is possible to any storage interfaces present on the device (EEPROM, flash memory, etc.). Playback of the content would be possible any number of times. What follows are the additional steps necessary for content to be stored and used on a mobile device:

1. The content is assigned a Lock Status Indicator (LSI) that will allow anyone to determine the current state of a file:

a) Set: the content has not been accessed yet

b) Unset: the content has either been played, or the flag has been manually set to this state

c) Delete: the content is available to be removed when either the resource is needed or a purge operation happens. Normally, content with an indicator set to this value would not be displayed through query operations. New content arrivals would also have the authority to overwrite/remove content with the delete indicator set.

2. The content is assigned all of the following storage attributes:

a) Directory: file storage directory relative to the root path

b) Creation Time: time the file was written to storage

c) Last Access Time: time the file was last read, updated, or any control information was changed (such as the LSI)

d) Size: number of bytes used in the persistent storage medium

e) Permissions: read, write and execute permissions for user and world (similar to UNIX method)

f) Content Type: Specific header type that identifies playback requirements (such as an Audible.Com content header)

3. The content is selected and played back using a media player capable of recognizing the media type (such as an Audible.Com certified media player). A playback pointer is maintained to keep track of the current listening position.

4. The content LSI is automatically set to unlock and access time is updated when the content is opened for playback.

5. The user can fast-forward, pause, rewind, stop and mark the contents LSI as delete from the player application. The application will also maintain the current playback position to allow restarting playback from the last played or paused position.

6. The user would be able to view, select, or change the LSI on any device storage media.

7. The user would have a secure personal storage area where content would be immune from access or deletion without entering a private key. This area could contain access IDs, passwords or financial information that would not normally be modified once created. Applications with appropriate access could read from this area but not modify or delete records.

8. The content could be further compressed and moved to the secure storage area for future reference. An application would use compression algorithms to archive a piece of content. Since most content arrives at the device in compressed form, this would be most useful applied to text-based media.

For one time use storage, the device must be able to store the content, regardless of type, to the local storage media. Storage should be possible to any storage interfaces present on the device (EEPROM, flash memory, etc.). Playback would be limited to one time from start to finish. Users would be able to suspend playback but never to go backwards and replay an item. The content provider, for copyright reasons, usually imposes this restriction. All items from the repeated use model are utilized in this model. What follows are the additional steps necessary for one-time use content to be stored and used on a mobile device:

1. The media player needs to maintain a Persistent Progress Indicator (PPI) to identify how far playback has progressed through the content file. The PPI will allow the media player to resume from the previous position after it is stopped, by storing the latest relative position during playback.

2. The media player MUST not allow the content to be played twice or backed up to replay a section. The PPI or similar construct is necessary for this function.

3. The media player and push server should support resumption of file transmissions when a connection is prematurely terminated. This is a facility that would use transmission checkpoints to confirm delivered blocks, and resume from the last successful point. Applications need to be declared Block Re-transmission Enabled (BRE) to comply with this specification.

In order to maintain a Persistent Storage file system, the present invention may use, but is not limited to, the following routines in maximizing storage efficiency:

1. A purge routine: examines files from a given directory path and below that have their delete LSI set. These files may be removed without confirmation required.

2. A compaction routine: re-orients files in the storage space to remove storage gaps. This would operate similarly to the disk optimization routines on PCs that remove gaps between files.

3. A cleanup routine: presents a list of candidate files that have been listened to, and may no longer be necessary.

4. A change mode routine: similar to a UNIX chmod, this would allow permission, ownership LSI changes.

5. A security routine: would allow PIN number setup and changes. This routine could also encrypt and store personal information using the PIN as the algorithm key.

6. An archive routine: this would move items into and out of the secured personal storage area. Optionally, this archive process would attempt to use compression algorithms to save on storage resources. This routine would require the same private key used for read access to store to the storage.

Several of the above described elements used in the delivery, storage, and playback method according to the present invention will be discussed in more detail below.

Lock Status Indicator (LSI).

The LSI program is used to denote the current disposition of a piece of multimedia content stored on a mobile device. The LSI allows for more intelligent handling of media files stored on a mobile device. With regard to stored media files, the LSI program can determine if the content file has been opened, played back, marked for deletion, or can be overwritten when storage space is depleted.

The LSI is preferably a multi-bit indicator that has several different states denoted by its character or numeric value. A file system manager application that handles requests for new storage, directory listings, marking of files for deletion, etc. is required on the mobile device. The LSI exists as microbrowser-compliant file organization header block used by the file system manager. The following are a list of descriptors and explanations of possible states in which the LSI may exist:

Default/Unset/Blank/0: This is the value the LSI contains when a directory entry is created. This value denotes that the media file has not been opened, read, or otherwise played back. New media files that arrive at the device will always be assigned this value no matter what value is sent in this field.

Set/Modified/1: This is the value the LSI contains when the media file has been opened for play back by any compliant player, or when set by an application program. There is no restriction for setting to or from this value multiple times.

Available/Overlay Enabled/2: This is the value the LSI is set to when the content has been plated back completely. Media files with an LSI set to this value may be overwritten at the discretion of the file system management application as storage needs demand. These files usually occupy the last storage area reclaimed when memory resources become strained; i.e., all deleted files and free memory is utilized before overwriting files with the “Overlay Enabled” value.

Delete/Marked for Deletion/3: This is the value the LSI is set to when a media player or application no longer needs to retain storage for a media file. When this value is set, any arriving media file may overlay or remove the storage allocated to this file. While similar to the “Overlay Enabled” value, this setting will actually have the highest priority when a new storage allocation request is received.

Persistent Progress Indicator (PPI).

The PPI program provides a method of playback of one-time use content stored on a mobile device. The PPI program allows for a playback mechanism that permits content to be accessed a single time by indicating how much content has been presented. By maintaining the relative position of playback in persistent storage on the device, a player will be able to ensure that content is presented only once. Multimedia that requires use restriction include files such as Internet radio that can have content only played once, but can be paused or resumed at a later time.

The PPI is an encrypted or encoded file that the multimedia player uses to determine how far playback has progressed through a file. By storing the relative position of playback, the PPI will allow the media file to be played only once. The PPI can be an optional file that could arrive when a piece of multimedia content is stored on the mobile device. By default, the multimedia content header contains a notation that signifies the file is for one time use only. When content is so annotated, a file with the same name and a .ppi extension must exist in the same directory for the player to open the content. This file will contain either a <NULL> (for un-played content) or an encoded value representing how far playback has progressed through the media file. For Example:

Media file: radio_{—}090700 PPI file: radio_{—}090770.ppi

Contains: streaming radio broadcast Contains: 0×4FCF

In this example, the streaming radio file radio_{—}090700 playback has started and progressed to a point before being stopped. The key value 0×4FCF corresponds to an offset in the media file where playback was stopped. The playback may resume on this file only from this offset position.

Personal Storage Access Area (PSAA)

The PSAA is a storage convention that can be used to provide a secure access area for a piece of multimedia content stored on a mobile device. The PSAA allows for more secure handling of media files stored in the mobile device. Multimedia content can be protected from access or deletion through the use of a private key. Files containing certain personal information could be secured on the mobile device, and protected from accidental or unauthorized practice. For example passwords used for login to remote systems or keys to applications can be stored in the PSAA and protected from unauthorized access and/or inadvertent deletion. Access identification, such as user names, keys, passwords, and the like that are used for, among other things, automated validation on remote systems can be similarly protected. Also, customer profiles, for examples, cookies, that can be used by remote or local application software, and financial information such as credit card numbers, Personal Identification Numbers (PINs), bank account numbers, and the like can be protected in the PSAA.

The PSAA is a logical storage convention that gives the impression that a file is not available for access without use a private key. When fist allocated on the mobile device, the PSAA is assigned an access key by the user. This encrypted key could be stored, for example, in a non-volatile memory on the mobile device, but would not be available for viewing by application software.

A user would be able to relocate files to this area and such files would no longer be available for access without the private key. Compliant applications, when accessed, would request the pri9vate key from the user and validate it against the stored key. Applications or file system routines would not normally be permitted access to these files, but could be access such if a key validation schema were implemented.

Since the PSAA is a logical convention, it could be implemented in way of several different ways. The following is a list of possible implementation procedures. This list is exemplary only, and other implementations methods could be used and fall within the scope of the invention.

File Naming.

This schema names the multimedia content using file names that are not recognized by standard access routines. For example, this schema could be implemented by using dot notations, such as file1 or .cantsee. Another possible implementation could be to use non-standard symbol notations, such as ˜file1, or ˜cantsee. Yet another possible schema could be the use of hidden directory notations such as .hidden/file1 or .hidden/cantsee.

Physical Location.

This schema would define an area where normal applications would not be allowed to access. The file system access routines would view this area as locked or in use, and would not attempt to read or write to it. This schema could be implemented by using a specific storage medium such as an entire flash card or secondary storage device. Another possible implementation of this schema would be the use of a range of byte locations on the storage device, such as byte address 1000 to address 2500 would be marked as “in use.”

Single Encrypted File.

This schema would use a single file with an encrypted content and would require decoding to access the desire file. By localizing the content into a single file, access can be more tightly controlled and decoding would be more difficult. The single file would still need to be stored in a manner not easily viewable by file access routines. For example, a file could be named bigsecure.lib, and would contain file1, file2, and file3.

Fractured Files.

This schema would break a secured file into multiple pieces with a key file used for reassembly. The individual files still would need to be stored in a manner not easily viewable by the file access routines. An example of this implementation would be fracturing file1 into file1.a, file1.b, file1.c, etc.

Block Retransmission Enabling (BRE)

Block Retransmission Enabling (BRE) provides a more reliable and efficient method of content delivery and retransmission to mobile devices. BRE is a file that is created, written, and maintained by the transmission application during the content delivery process. When block is successfully delivered, the highest sequential block number is recorded. If the connection is prematurely terminated, the transmission application requests resumption of transmission from the block number in this file. BRE is not needed once delivery is successfully completed.

The BRE file only exists for the duration of a file transmission. The following is an example of a BRE implementation:

1. An application program (receiver) accepts a connection request from a media server (sender);

2. Receiver writes out a BRE file with a zero (o) to denote no blocks have been successfully transmitted.

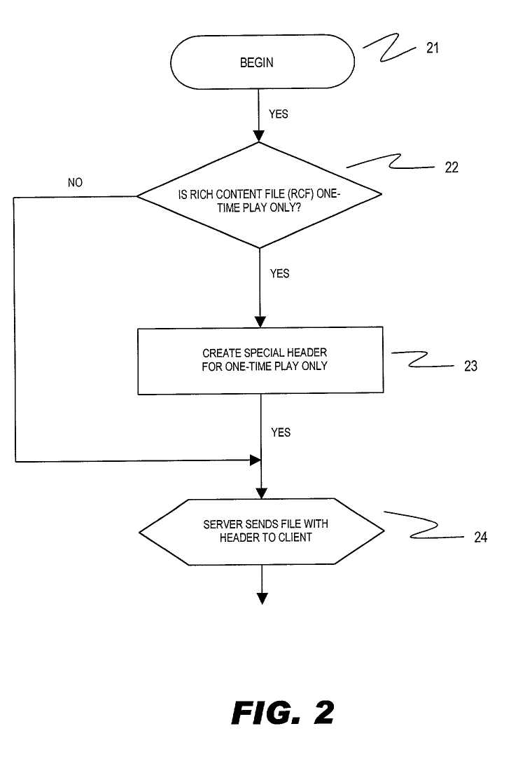

FIGS. 2 through 7 illustrate flow diagrams of an exemplary data network using a mobile device, in accordance with the invention. FIG. 2 illustrates a flow diagram of a method for storing data content on a push server, in accordance with the invention.

A process for transmitting and storing multimedia content at the server side of the data network will now be described with reference to FIG. 2. At step 21, Rich Content Files (RCF) from content servers 12, 13, are transmitted to the push proxy or push server platform 14 over the Internet 13. At step 22, a determination is made as to whether the RCF is a onetime play only. If the RCF is a one time play only, a special header identifying the RCF as a one-time play only file is created at step 23, and server 14 sends the file with the header content to the client at step 24. If the RCF is a multi-play file, step 22 is skipped and the RCF multi-play file proceeds directly from step 224 and is marked as a multi-play file and sent from server 14 to the client.

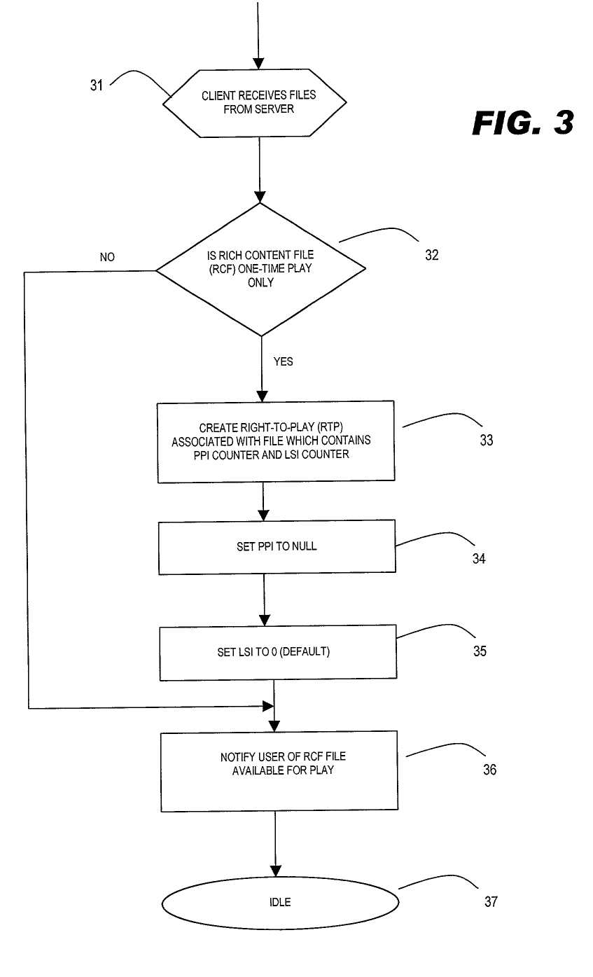

Various processes for receiving, storing and playing an RCF file on the client side (the mobile device) will now be described with reference to FIGS. 3-7. Referring to FIG. 3, an RCF file from the server side is received by a client on a mobile device at step 31. At step 32, a determination is made. As to whether the RCF file is a on-time play or multi-play file. If the RCF is a single play file, the process proceeds to step 33 where a Right-to-Play (RTP) associated file is created which contains a PPI counter and a LSI indicator. The process then proceeds to step 34 and the PPI is set to a value indicating either the file beginning (null), or to some other value representing a position to which the file has been played. The process then proceeds to step 35 whether the LSI is set to 0 (Default). The user is then notified at step 36 of the RCF file, which is available for play. At step 32, if the RCF file is not a onetime play file, the process proceeds directly to step 36 where the user is notified of the RCF file, which is ready for play. The process then proceeds to step 37, and becomes idle.

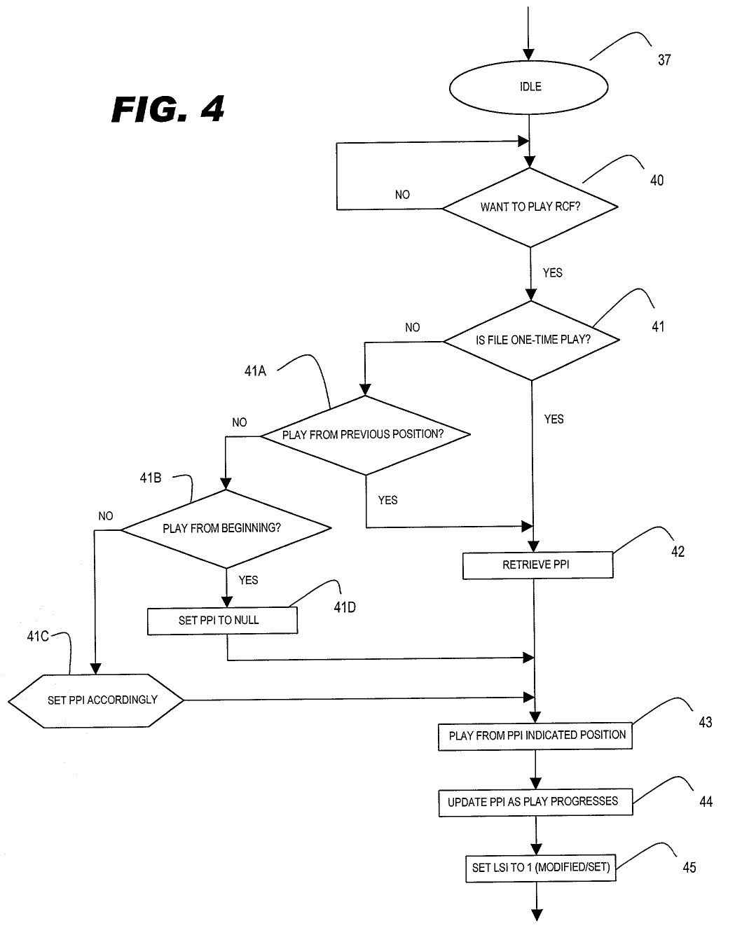

Referring to FIG. 4, the user is asked if the RCF is to be played at step 40. If the user accepts, a determination is made as to whether the RCF is a one-time play file at step 41. If the RCF is a one-time play only file, the PPI is retrieved at step 42 and the RCF is played back from the positioned indicated by the PPI at step 43. At step 44, the PPI is updated as play progress, and at step 45 the LSI is set to 1 (Modified/Set).

If the RCF is determined not to be a one-time play only file at step 41, the process proceeds to step 41A and the user is asked if the RCF should be played from the previous position. If the user accepts this, the process proceeds to step 42 and proceeds through steps 43, 44, and 45 as described above. If the user does not want to play the RCF from the beginning, the process proceeds to step 41B where the user is asked if the RCF should be played from the beginning. If the user accepts this querrie, the PPI is set to Null at step 41D, and the process further proceeds to step 43 where play begins from the indicated PPI position, the PPI is updated as play progress at step 44, and the LSI is set to 1 (Modified/Set) at step 45. If at step 41B the user declines to play the RCF file from the beginning, the PPI is set according at step 41C and the process proceeds to step 43 where play begins from the indicated PPI position, the PPI is updated as play progress at step 44, and the LSI is set to 1 (Modified/Set) at step 45.

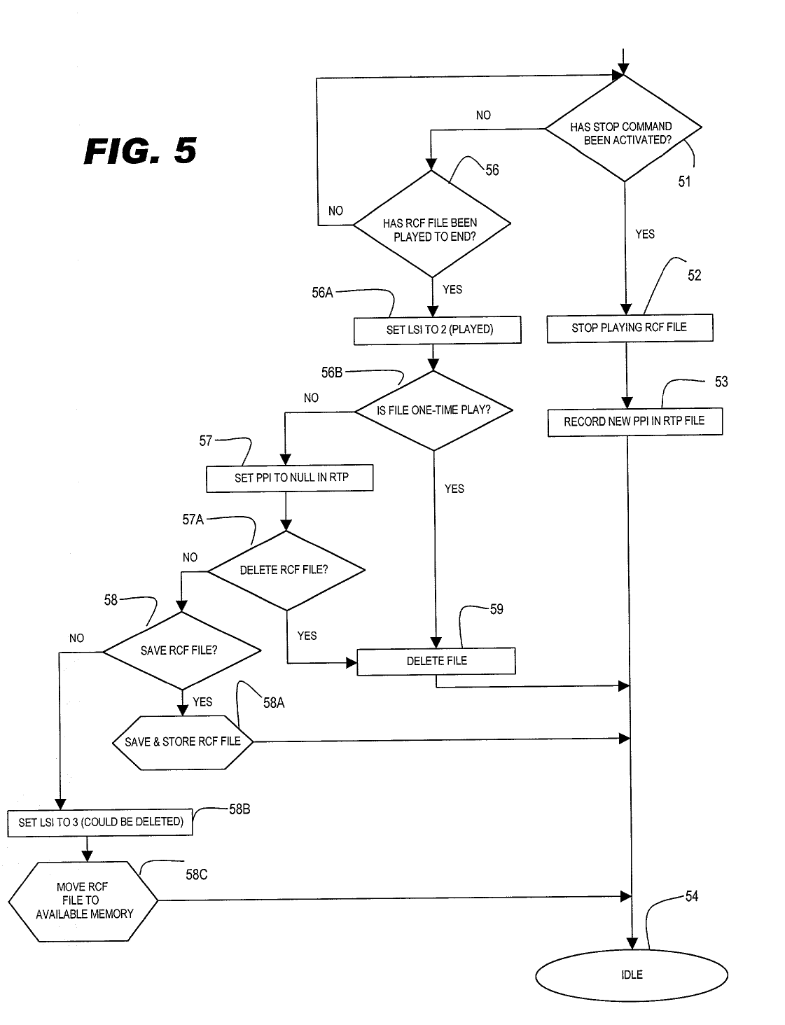

Referring to FIG. 5, after the LSI is set at step 45, the process proceeds to step 51, where a determination is made as to whether or not a stop command has been activated. If a stop command has been activated, play of the RCF is stopped at step 52, and a new PPI is set in the RTP file. Then process then proceeds to idle at step 54. If, at step 51, no stop command has been activated, another determination is made at step 56 as to whether the RCF file has been played to the end. If the RCF has not been played to the end, the process returns to step 51 and proceeds again as described above. If at step 51, the RCF file has been played to the end, at step 56A, the LSI is set to 2 (Played) and a determination is made at step 56A as to whether or not the file is a one-time only play file. If at step 56A, the RCF file is a one-time play only file, the file is deleted at step 59 and system proceeds to idle at step 54. If, at step 56B, the RCF is determined not to be a one-time play only file, the PPI is set to null in the RTP at step 57, and, at step 57A, the user is asked whether the RCF file should be deleted. If the user desires the RCF file to be deleted, the file is deleted at step 59 and the system proceeds to idle at step 54. If, at step 57A, the user decides not to delete the file, the user is asked at step 58 whether the file should be saved. If so, the RCF file is saved and stored at step 58A and the system proceeds to idle at step 54. If, at step 58A, the user decides not to save the RCF file, at step 58B, the LSI is set to 3 (Could be Deleted) and the RCF file is moved to available memory at step 58C and the system proceeds to idle at step 54.

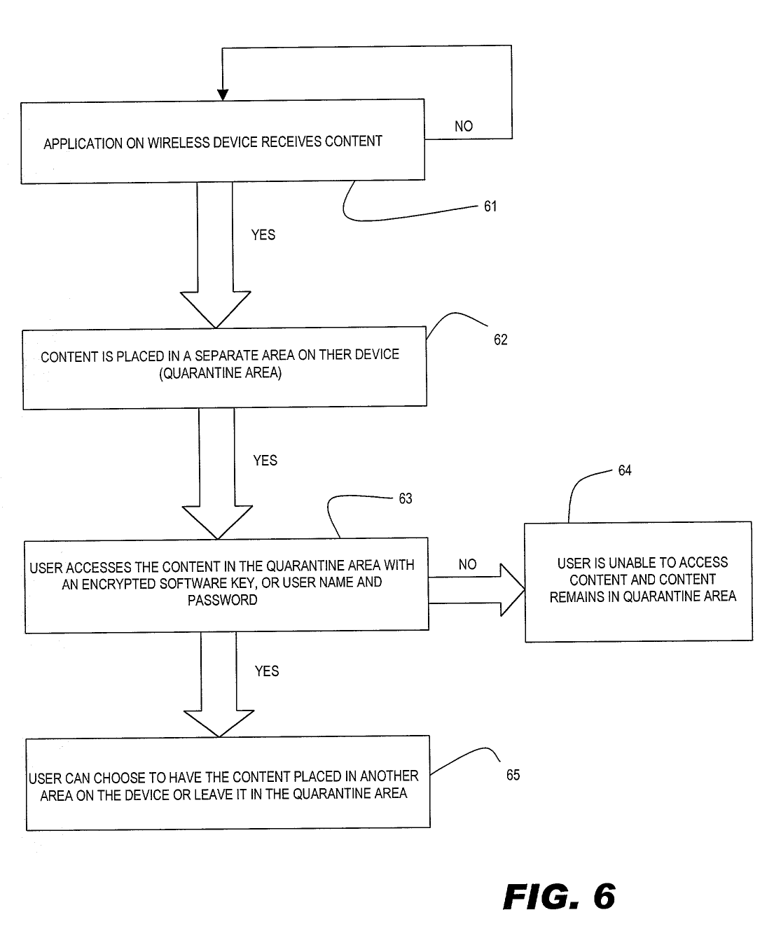

FIG. 6 illustrates an example workflow diagram for the PSAA storage convention. In this example, at step 61 an application on a mobile device receives multimedia content. If the application on the mobile device does not receive multimedia content, the process of step 61 is repeated. If the application does receive multimedia content, the content is placed in a separate area on the device, such as a quarantine area in step 52. At step 63 the user accesses the multimedia content in the quarantine area with an encrypted software key, or a user name and password. If the user is unable to access the content, at step 64 the content is maintained in the quarantine area. If the user is able to access the content in step 63, at step 65, the user can then choose to have the content placed in another area on the device or can leave the content in the quarantine area on the mobile device.

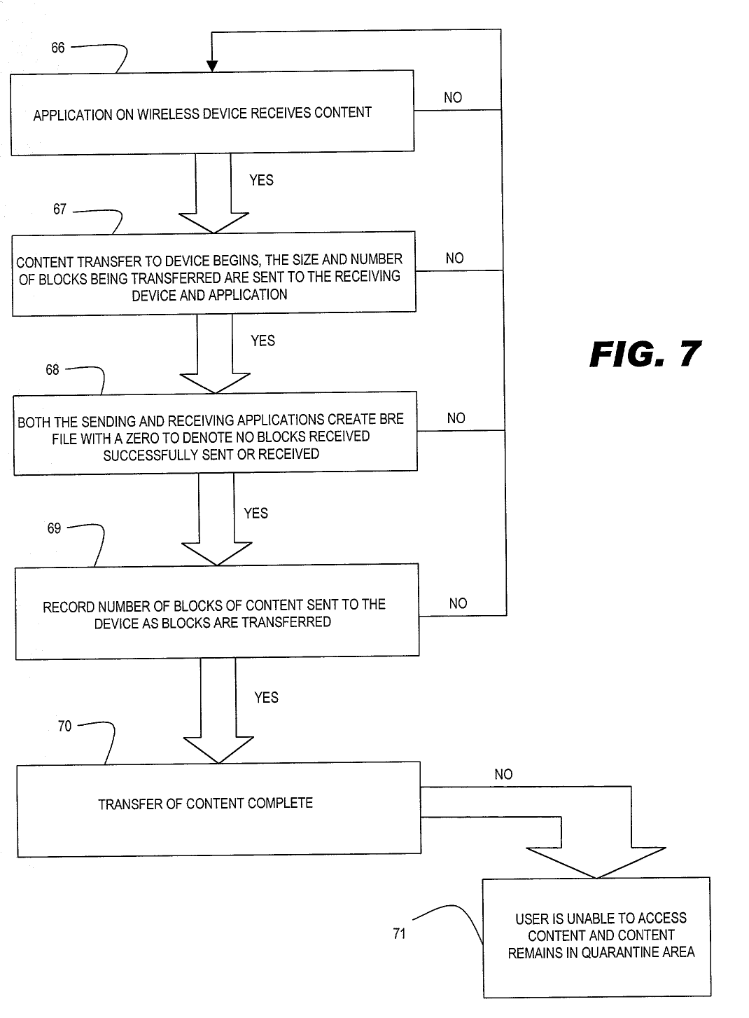

FIG. 7 illustrates an example workflow diagram for the BRE program. In FIG. 7, at step 66 an application on the mobile device accepts a connection from a content server. If no connection is established, the process repeats at step 66. If a connection is accepted, content transfer begins at step 67, and the size and number of blocks being transferred is sent from the content server to the application on the mobile device. If the size and number of blocks being transferred is not received, the process returns to step 66. If the information relating to the size and number of blocks being transferred is received, at step 68, both the sending and receiving applications create a Block Transmission Enabling (BRE) file having a “0” if no blocks have been successfully sent or received, and the process returns to step 66. If blocks have been received, at step 69, the application records the number of content blocks sent to the device as the blocks are transferred. If this process is interrupted, the process returns to step 66. If not, the process proceeds to step 70 where transfer of content is acknowledged as successfully competed. If the transfer of content has not been successfully completed, at step 71, a request is sent back to the sending application to resend blocks starting with those blocks after the last successfully transferred block.

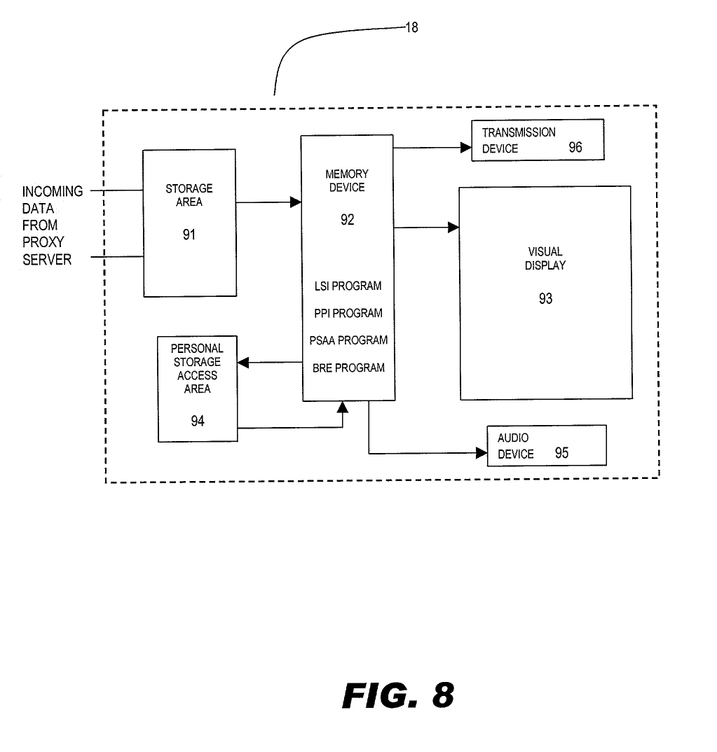

FIG. 8 represents, in schematic block diagram form, an example of a mobile device 18 that can implement the receipt, storage, and playback functions according to the present invention. Incoming data content from push proxy or push server platform 14 is received into a storage area 91. Data from storage area 91 is accessed through memory device 92. Memory device 22 stores the LSI program, the PPI program, the PSSA storage convention, and the BRE file program. If the PSAA convention is accessed, incoming data so identified is transferred to PSAA 94, and then, as requested, are retrieved by memory 92 for play back. Incoming data is accessed for playback from memory device 92. The LSI and PPI programs are accessed, and the data is played, stored, or deleted from memory 92. If play back is desired, the data is sent to the visual display 93 and/or audio device 95. If during intake of transmitted data the connection with the push proxy is prematurely lost, the BREE program requests retransmission through transmission device 96.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A system for delivery, storage, playback and management of data on a wireless device, comprising:
a. a content storage device that stores and transmits a data stream;
b. a proxy server that receives the data stream sent from the content server, marks the data as single-use data or multi-use data, and transmits at least a portion of that data stream to a data network,
c. a transmission device that transmits the data stream from the data network to a wireless device, the wireless device further comprising;
i. a storage area that stores data from the data stream sent from the transmission device;
ii. a data indicator device to indicate type and status of the data in the storage device;
iii. a data player on which data from the storage device is played back to a user; and
iv. a data retransmission device that generates a signal if the data stream is lost from the transmission device, and transmits the signal to the proxy server to re-establish transmission of the data stream.

2. A system for delivery, storage, and playback of data on a wireless device according to claim 1, wherein the data indicator device comprises two data indicator programs, a one-time play only program to identify and manage one time play only data, and a multi-play program to identify and manage multi-play data.

3. A system for delivery, storage, and playback of data on a wireless device according to claim 1, wherein the storage area further comprises a personal storage access area that stores data marked as restricted access data for a user, wherein data is marked by:
a. a user authentication process, using an encryption key or a combination of username and password, on the device to access newly delivered content
b. a data transfer process to move data to other areas on the device that are not secure and do not require authentication after the user has been authenticated.

4. A system for delivery, storage, and playback of data on a wireless device according to claim 1, further comprising a block retransmission enabling device to re-establish a communication link between the proxy server and the wireless device if the communication link is prematurely lost.

5. A wireless device for receiving, storing, and playing data transmitted over a wireless network, comprising:
a. a storage area capable of receiving and storing data transmitted over a wireless network in one or more files;
b. a transmission device capable of sending a signal over the wireless network; and
c. a memory unit having stored thereon a control program to control storage and playback of the data; the control program comprising;
i. a multi-use data status indicator program to determine a current status of one or more files containing multi-use data stored in the storage area;
ii. a single-use data progress indicator program to control playback of single-use data stored in one or more files in the storage area;
iii. a personal storage access area storage convention for controlling access and use of certain data stored in the storage area;
iv. a block re-transmission enabling program to resume data delivery to the wireless device after a loss of connection from the wireless network.

6. A method for delivering, storing, and playing data transmitted over a wireless network, comprising;
a. storing multimedia data content storage device and transmitting the multimedia data content in a data stream;
b. receiving and storing the multimedia data content on a proxy server;
c. marking the multimedia data content as single-use data or multi-use data, and transmitting at least a portion of the marked multimedia data content to a data network;
d. receiving and storing the marked multimedia content on a wireless device;
e. determining whether the marked multimedia data content is single use data or multi-use data;
f. marking single use multimedia data content with an first indicator to ensure the single use multimedia data is only played once; and
g. marking multiuse multimedia data content with an second indicator to allow the multiuse multimedia data content to be played back when desired.

7. A method for delivering, storing, and playing data transmitted over a wireless network according to claim 6, further comprising:
a. marking multimedia data content received from the proxy server as restricted access data; and
b. storing the restricted access data in a segregated storage access area.

8. A method for delivering, storing, and playing data transmitted over a wireless network according to claim 7, wherein data marked as restricted access can only be accessed using a private software key.

9. A method for delivering, storing, and playing data transmitted over a wireless network according to claim 8, wherein the private software key comprises an encrypted file content, a file dot notation not recognized by standard access routines, marked byte addresses, or fractured files.

10. A method for delivering, storing, and playing data transmitted over a wireless network according to claim 6, further comprising enabling a block retransmission of multimedia data content from the proxy server if the multimedia data content from the proxy server is interrupted.

11. A method for delivering, storing, and playing data transmitted over a wireless network according to claim 6, wherein data marked as single use multimedia content is deleted after complete playback.

12. A method for delivering, storing, and playing data transmitted over a wireless network according to claim 6, wherein data marked as multiuse multimedia data content is deleted after complete playback.

13. A method for delivering, storing, and playing data transmitted over a wireless network according to claim 6, wherein data marked as multiuse multimedia data content is saved after complete playback.
